(19) United States
(12) Patent Application Publication
(10) Pub. No.: US 2005/0226674 A1
(43) Pub. Date: Oct. 13, 2005

(54) Automatic drywall compound distribution system

(76) Inventors: Kurt Walker, Akron, OH (US); Gina Walker, Akron, OH (US)

Correspondence Address: Kurt Walker, 151 Fremont Avenue, Akron, OH, 44312, US

(21) Appl. No.: 10/796,002

(22) Filed: Mar. 10, 2004

(51) Int. Cl. B43K 5/02; B43K 5/18; B43K 7/10; A46B 11/00; B05C 11/10; B28C 5/06; E04D 15/00; E04F 21/00; E04G 21/14

(52) U.S. Cl. 401/5; 366/13; 156/575; 52/749.1

(57) ABSTRACT

An automatic drywall compound distribution system which includes a portable hopper to hold and distribute drywall compound, a motor controlled auger to collect and distribute compound out the bottom of the hopper and through a connected flexible tubing to a trigger operated drywall blade which will then, on demand, evenly distribute drywall compound onto the wall.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. This invention relates to the storage, dispensing and use of drywall joint compound in building applications. More particularly, in applying drywall joint compound to joints using an automatic drywall compound distribution system which includes a portable hopper to hold and distribute the drywall compound, a motor controlled auger to collect and distribute compound out the bottom of the hopper and through a connected flexible tubing to a trigger operated applicator. Said attached applicator would then, on demand, evenly distribute drywall compound onto the wall.

2. Applying drywall joint compound to joints is a very labor intensive job if done manually. In using the present machines, the job is very demanding physically and in time causes injury to the back and shoulders of the worker because of the weight of the device and the physical force necessary to eject the joint compound from the device and apply it to the wall.

3. Accordingly, a principal object of this invention to provide a system in which a portable hopper holds and distributes the drywall compound using a motor controlled auger to collect and distribute compound, transferring the compound from the hopper to a trigger operated applicator. The said applicator would then, on demand, evenly distribute drywall compound onto the wall.

4. Another object is to provide a system that can be easily filled with a large amount of joint compound therefore eliminating the wasted time of reloading multiple times to complete the job. Still another object is to provide a system which can be used for first coats as well as finish coating.

5. Various types of drywall compound containing and dispensing apparatus are know in the art. Typical of these devices is the “Dry Wall Taping Machine Having An Improved Applicator Head” is detailed in U.S. Pat. No. 4,208,239, dated Jun. 17, 1980, to Harold M. Lass. The device is hand operated and includes a tubular body designed for holding by the operator, with a tape applicator head portion at one end. The tool is supplied with drywall tape cement from a supply under pressure and a supply of drywall tape is carried from the main body of the applicator. The tape is fed through the applicator head onto the wall joint to be taped. In the applicator head, a pair of tape drive wheel portions engage the tape and press it against the wall for taping a seam between the two adjacent pieces of drywall.

6. An object of this invention is to provide a new and improved automatic drywall compound distribution system which is portable and capable of distributing compound at a desirable rate and eliminating both the stress and strain of carrying around the weight of the compound by the worker and the need of constant filling of the tool.

7. Another object of the invention is to provide an automatic drywall compound distribution system which includes a portable hopper to hold and distribute the compound using a motor driven auger to collect and distribute compound out the bottom of the hopper, through an attached flexible tubing to a trigger operated applicator which will then, on demand, evenly distribute the compound onto the wall.

### BRIEF SUMMARY OF THE INVENTION

These and other objects of the invention are provided in a new and improved automatic drywall compound distribution system which includes a preferred embodiment, a portable hopper to hold and distribute drywall compound which can easily be filled with compound by pouring it into the top. The compound is then transferred from the hopper to the applicator using a motor driven auger to collect and distribute the compound out the bottom of the hopper, through an attached flexible tubing to a trigger operated applicator which will then, on demand, evenly distribute the compound onto the wall.

### BRIEF DESCRIPTION OF THE SEVERAL VIEWS OF THE DRAWING

This invention will be better understood by reference to the accompanied drawings wherein:

FIG. 1 is a perspective view of the automatic drywall compound distribution system.

FIG. 2 is a perspective top view of the hopper, pipe sleeve and auger of the automatic drywall compound distribution system.

FIG. 3 is an exploded view of the main components used to operate the automatic drywall compound distribution system omitting the hopper.

FIG. 4 is a side perspective view of the applicator of the automatic drywall compound distribution system.

FIG. 5 is a perspective view of the applicator of the automatic drywall compound distribution system.

FIG. 6 is a side perspective view of the hopper and pipe sleeve of the automatic drywall compound distribution system.

FIG. 7 is a rear perspective view of the automatic drywall compound distribution system.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what presently is believed to be the best mode of carrying out the invention.

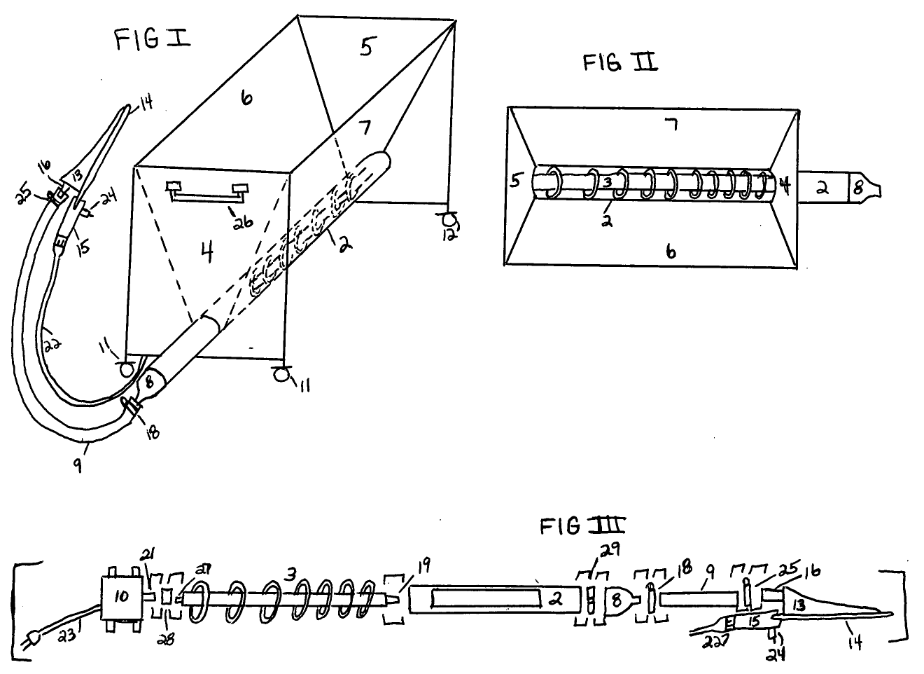

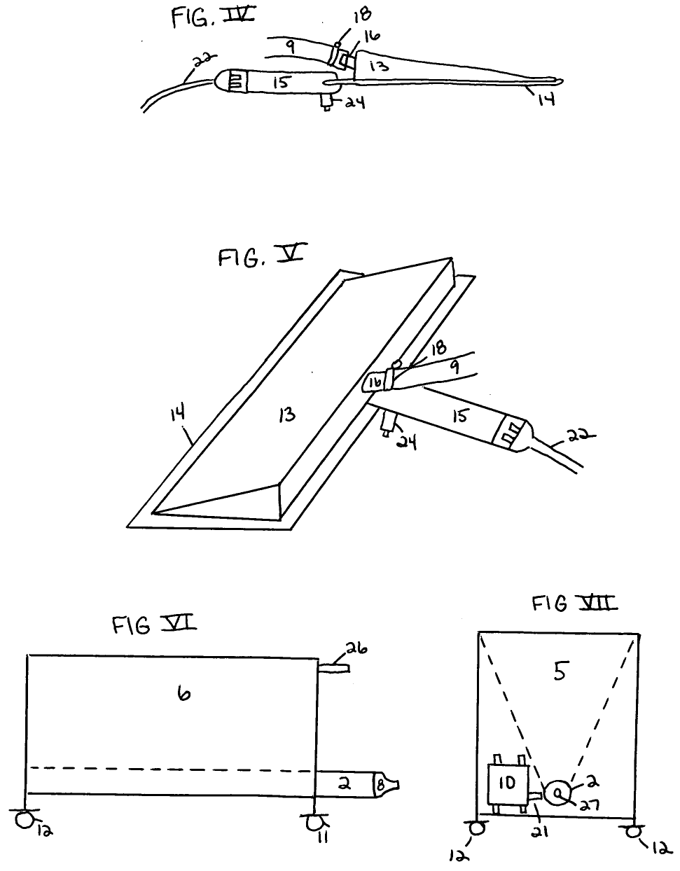

Referring to FIGS. 1-7 of the drawings, a preferred embodiment of the automatic drywall compound distribution system is generally illustrated by reference numeral 1 and the applicator by reference numeral 17. Automatic compound distribution system 1 is comprised of a square panel 4 at the front and a square panel 5 in the rear attached to left side panel 6 and right side panel 7 to create a funnel shaped hopper to hold drywall compound and allow gravity to feed the compound to the auger 3. Wheels 11 are mounted on the front and wheels 12 are mounted on the rear of the hopper and a handle 26 is mounted to the front of the hopper to allow easy mobility.

Left panel 6 and right panel 7 attached at an angle to each side of opening in pipe sleeve 2. Auger 3 mounted inside of pipe sleeve 2 powered by a power transmission gear motor 10 or other various types of motor. Gear motor 10 is connected to back end of auger 3 through rear panel 5 to knob shaft 27 on end of auger 3 and connected to drive shaft 21 on motor 10 with coupling 28. Motor powered by outlet cord 23. Alignment pin 19 on front end of auger 3 is set in center of alignment bar 29 attached to inside o pipe sleeve 2. Cone shaped reducer 8 threaded onto end of pipe sleeve 2. Flexible tubing 9 connected to cone shaped reducer 8 with hose clamp 18. The other end of the flexible hose 9 connected to fitting 16 on applicator 17 with a hose clamp 25. Compound then travels into the compound spreader 13 and out onto blade 14 to be applied onto the wall. Applicator 17 also includes a handle 15 which has a low voltage push button switch, vacuum switch, air operated electrical switch or 125/250 VDC single pole throw switch to be used as a trigger 24 to control compound flow. Trigger 24 powered by a quick loc cord 22 connected from end of handle 22 to rear of motor 10.

Aluminums, metals or plastics can be used to manufacture the components of this system and this variation will not affect the outcome.

It will be appreciated by those skilled in this area that the automatic drywall compound distribution system of this invention offers a practical, portable and efficient devise for dispensing of the drywall compound. Furthermore, the flexible hosing 9 is sufficiently long enough to make the application of the drywall compound very time efficient. Moreover, the auger 3 is more than sufficient to move the drywall compound at a desirable rate through the flexible hosing 9. Furthermore, the portable hopper system is easily filled with the drywall compound by simply dumping a full bucket into the hopper at a time. The portable hopper also eliminates the need to carry around heavy containers filled with compound to be applied to the wall.

As various changes could be made in the above constructions without departing from the scope of the invention, it is intended that all matter contained in the above description or shown in the accompanying drawings shall be interpreted as illustrative and not in a limiting sense.

1. An automatic drywall compound distribution system for storage, dispensing and use of drywall compound, said automatic drywall compound distribution system comprising a portable hopper for containing of the drywall compound, a motor driven auger to collect and distribute the compound out of the bottom of the hopper, through an attached flexible tubing to a trigger operated applicator which will then, on demand, evenly distribute the compound onto the wall.

2. The automatic drywall compound distribution system of claim 1 comprising of a portable hopper means supporting said hopper, said motor means, and said auger.

3. The automatic drywall compound distribution system of claim 1 where said motor driven auger means comprises an electric or transmission gear motor and an auger, said motor connected to said auger and wherein said motor and auger are connected to said hopper.

4. The automatic drywall compound distribution system of claim 1 where said motor driven auger means comprises an auger that turns inside pipe sleeve to collect and distribute the drywall compound from said hopper into said flexible tubing.

5. The automatic drywall compound distribution system of claim 1 where said flexible tubing means comprising a flexible tubing to carry drywall compound from said hopper, powered by said motor driven auger, to said trigger operated applicator.

6. The automatic drywall compound distribution system of claim 1 comprising means is filled with compound by dumping compound into said portable hopper from the top causing gravity to feed to compound to said motor driven auger.

7. The automatic drywall compound distribution system of claim 6 comprising of said portable hopper also includes a handle on front of said hopper and wheels on front and rear of said hopper for easy mobility.

8. The automatic drywall compound distribution system applicator of claim 1 comprising means applicator is flat drywall spreading blade attached to the said hopper by said flexible tubing with hose clamps, said applicator has a compound spreader mounted on one side fed by compound from said flexible tubing.

9. The applicator of claim 8 comprising means trigger controlled by the operator, said switch when depressed, said motor and said auger are activated to push the compound through the said flexible tubing, into the compound spreader and onto the wall.

10. The applicator of claim 8 comprising means wherein the trigger located on the handle of the applicator is powered by a quick lock cord connected to the end of said handle and connected on the other end to the said motor.

11. The applicator of claim 8 comprising means a compound spreader which, as the compound enters the applicator, spreads and distributes the compound onto the blade to be applied to the wall.

12. The automatic drywall compound distributing system of claim 5 comprising of said flexible tubing is connected to the hopper by a cone shaped reducer. Said cone shaped reduce connects on one end to said flexible tubing by a hose clamp, said cone shaped reducer connects with threading to the end of the pipe sleeve on the other end.

13. The automatic drywall compound distributing system of claim 12 comprising of said pipe sleeve is a sleeve slightly larger than said auger allowing the said auger to freely turn inside, top of said pipe sleeve is open allowing compound to enter said sleeve and then be forced through said pipe sleeve to said flexible tubing.

14. The automatic drywall compound distributing system of claim 1 comprising means of motor driven auger, said auger is connected on one end to motor by a coupling connecting motor shaft to knob shaft on said auger, said alignment pin on other side of said auger sits inside of alignment bar inside of pipe sleeve.
